(19) United States
(12) Patent Application Publication
(10) Pub. No.: US 2024/0420665 A1
(43) Pub. Date: Dec. 19, 2024

(54) Outdoor Instrument-Holding Device

(71) Applicant: Mark Davis, Durango, CO (US)

(72) Inventor: Mark Davis, Durango, CO (US)

(21) Appl. No.: 18/426,850

(22) Filed: Jan. 30, 2024

Related U.S. Application Data
(60) Provisional application No. 63/507,856, filed on Jun. 13, 2023.

(51) Int. Cl. G10G 5/00; F16M 13/02

(52) U.S. Cl. CPC G10G 5/00; F16M 13/02

(57) ABSTRACT

An outdoor instrument-holding device is provided. The device is comprised of at least one strap, a mounting plate, and receiving arms. The strap may be fastened to an outdoor object such as a tree, and the mounting plate is attached to the straps through an opening. The straps are adjustable to the size and circumference of the outdoor object in use. The receiving arms are attached to the mounting plate through a base such that the arms can safely and securely hold an instrument off the ground in an outdoor setting.

### CROSS-REFERENCE TO RELATED APPLICATION

The present application claims priority to, and the benefit of, U.S. Provisional Application No. 63/507,856, which was filed on Jun. 13, 2023, and is incorporated herein by reference in its entirety.

### FIELD OF THE INVENTION

The present invention relates generally to the field of instrument holders. More specifically, the present invention relates to an outdoor instrument-holding device that can be attached around an outdoor feature (such as, but not limited to, a tree) in order to suspend a musical instrument in a safe position off of the ground. Accordingly, the present disclosure makes specific reference thereto. Nonetheless, it is to be appreciated that aspects of the present invention are also equally applicable to other like applications, devices, and methods of manufacture.

### BACKGROUND

When a musical instrument is left unattended outdoors, it can be easily damaged. Given the unpredictability of the outdoor environment, the instrument could easily get stepped on by a passerby or even by the musician. Furthermore, the ground often contains dirt, rocks, twigs, and other debris that could scuff, scratch, or even puncture the instrument. This damage is not only aesthetically unpleasing but can also compromise the sound quality and overall functionality of the instrument.

While one might argue that storing the instrument in a case when not in use is a solution, it is not always a feasible or convenient one. Musicians might be in the middle of a set, taking a short break, or simply wish to keep their instrument within arm's reach without the hassle of constantly putting it back in its case.

Further, if an instrument sustains significant damage, it could be rendered entirely unusable. Even if it can still produce sound, the quality might be compromised, or it may need extensive and expensive repairs to bring it back to its original state. Thus, it is crucial for musicians to be vigilant about the care and protection of their instruments, especially in outdoor settings.

Therefore, there exists a long-felt need in the art for a device that stores and holds instruments off the ground for convenient use by a musician. More specifically, there exists a long-felt need in the art for an outdoor instrument-holding device that prevents potential damage to an instrument that may come unto the instrument by stepping, kicking, or dropping things onto the instrument due to the instrument's presence on a ground surface. Furthermore, there exists a long-felt need in the art for an outdoor instrument-holding device that can be applied to an object outdoors of any size or circumference to common outdoor objects, such as trees or poles, and may therefore be universally applied in any outdoor setting.

The subject matter disclosed and claimed herein, in one embodiment thereof, comprises an outdoor instrument-holding device. The device is comprised of a strap, a mounting plate, and receiving arms. The strap is secured around an outdoor object such as a tree, and the receiving arms can be used to securely hold the neck of an instrument like a guitar in place and elevated off the ground. The receiving arms are padded to protect the exterior of the instrument neck.

In this manner, the outdoor instrument-holding device of the present invention accomplishes all the foregoing objectives and provides a solution for musicians needing safe and convenient access to their instruments in an outdoor setting. Additionally, the present invention aids in preventing potential damage to an instrument that may come unto it by stepping, kicking, or dropping things on it due to its presence on the ground. Furthermore, it can be universally applied in any outdoor setting.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an outdoor instrument-holding device comprised of at least one strap, a mounting plate, and receiving arms. The device is comprised of at least one strap, at least one mounting plate, and at least one receiving arm. The device is designed to be secured to an outdoor object, such as, but not limited to, a tree, with at least one strap that wraps around the object and is held together through at least one securing fastener. A musical instrument can then be placed within the receiving arms of the device, which is held to the straps by the mounting plate.

The length of the strap may be adjusted with at least one adjustment fastener to fit securely around an object of any size. The securing fastener is preferably (but not limited to) a clip or buckle which allows the strap to be secured around an object, surface, etc. The mounting plate may be comprised of at least one opening through which the strap of the device can be passed through to secure the mounting plate to the object.

At least one, but preferably two, receiving arms of the device are attached to the base and extend outwardly. The arms can hold the neck of an instrument such as, but not limited to, a guitar, ukulele, violin, or any other such musical instrument. The receiving arms may be covered in padding, in one embodiment, to prevent damage to the exterior of the instrument within the arms.

The present invention is also comprised of a method of using the device. First, a device is provided comprised of at least one strap, at least one mounting plate, and at least one receiving arm. Then, the strap can be placed through at least one opening of the mounting plate. Then, the strap is placed around an object, surface, etc., and is secured around the object via the securing fastener. Next, a portion (i.e., a neck) of at least one instrument can be placed within the receiving areas, such that the instrument is suspended from the arms above a ground surface.

Accordingly, the outdoor instrument-holding device of the present invention is particularly advantageous as it provides a solution for musicians needing safe and convenient access to their instruments in an outdoor setting. Additionally, the present invention aids in preventing potential damage to an instrument that may come unto it by stepping, kicking, or dropping things on it due to its presence on the ground. Furthermore, it can be universally applied in any outdoor setting through adjustable straps that are securable to a tree, pole, or any other such outdoor object. In this manner, the outdoor instrument-holding device overcomes the limitations of existing instrument holders known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an enhanced perspective view of one potential embodiment of an outdoor instrument-holding device of the present invention while secured around an object in accordance with the disclosed architecture;

FIG. 2 illustrates a perspective view of one potential embodiment of an outdoor instrument-holding device of the present invention while secured around an object in accordance with the disclosed architecture; and

FIG. 3 illustrates a flowchart of a method of using one potential embodiment of an outdoor instrument-holding device of the present invention in accordance with the disclosed architecture.

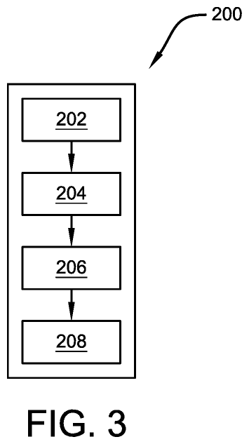

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that stores and holds instruments off the ground for convenient use by a musician. More specifically, there exists a long-felt need in the art for an outdoor instrument-holding device that prevents potential damage to an instrument that may come unto the instrument by stepping, kicking, or dropping things onto the instrument due to the instrument's presence on a ground surface. Furthermore, there exists a long-felt need in the art for an outdoor instrument-holding device that can be applied to an object outdoors of any size or circumference to common outdoor objects, such as trees or poles, and may therefore be universally applied in any outdoor setting.

The present invention, in one exemplary embodiment, is comprised of an outdoor instrument-holding device comprised of at least one strap, at least one mounting plate, and at least one receiving arm. The device is designed to be secured to an outdoor object, such as, but not limited to, a tree, with at least one strap that wraps around the object and is held together through at least one securing fastener and wherein a musical instrument can then be placed within the receiving arms of the device, which is held to the straps by the mounting plate.

The length of the strap may be adjusted with at least one adjustment fastener to fit securely around an object of any size. The securing fastener is preferably (but not limited to) a clip or buckle which allows the strap to be secured around an object, surface, etc. The mounting plate may be comprised of at least one opening through which the strap of the device can be passed through to secure the mounting plate to the object.

At least one, but preferably two, receiving arms of the device are attached to the base and extend outwardly such that the arms can hold the neck of an instrument such as, but not limited to, a guitar, ukulele, violin, or any other such musical instrument. The receiving arms may be covered in padding in one embodiment, to prevent damage to the exterior of the instrument within the arms.

The present invention is also comprised of a method of using the device. First, a device is provided comprised of at least one strap, at least one mounting plate, and at least one receiving arm. Then, the strap can be placed through at least one opening of the mounting plate. Then, the strap is placed around an object, surface, etc., and is secured around the object via the securing fastener. Next, a portion (i.e., a neck) of at least one instrument can be placed within the receiving areas such that the instrument is suspended from the arms above a ground surface.

Accordingly, the outdoor instrument-holding device of the present invention is particularly advantageous as it provides a solution for musicians needing safe and convenient access to their instruments in an outdoor setting. Additionally, the present invention aids in preventing potential damage to an instrument that may come unto it by stepping, kicking, or dropping things on it due to its presence on the ground. Furthermore, it can be universally applied in any outdoor setting through adjustable straps that are securable to a tree, pole, or any other such outdoor object. In this manner, the outdoor instrument-holding device overcomes the limitations of existing instrument holders known in the art.

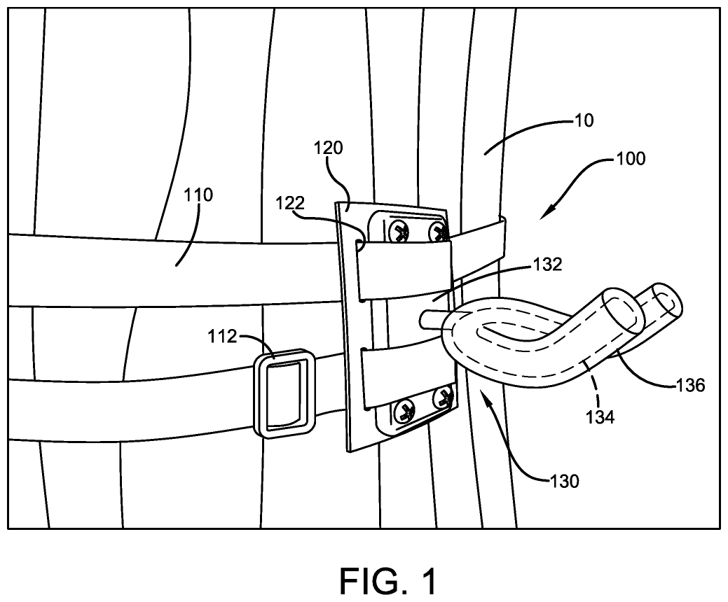

Referring initially to the drawings, FIG. 1 illustrates a perspective view of one potential embodiment of an instrument-holding device 100 of the present invention in accordance with the disclosed architecture. The device 100 is comprised of at least one strap 110, at least one mounting plate 120, and at least one receiving arm 134. The device 100 is designed to be secured to an outdoor object 10, such as, but not limited to, a tree, with at least one strap 110 that wraps around the object 10 and is held together through at least one securing fastener 114. A musical instrument can then be placed within the receiving arms 134 of the device 100, which is held to the straps 110 by the mounting plate 120.

The strap 110 of the device 100 may be comprised of any material known in the art but is preferably comprised of a thick and durable material fit for outdoor use such as, but not limited to, rope, nylon, or braided polyester. The strap 110 preferably has a width of at least one inch but may be of any size thickness or length that is suitable for the user.

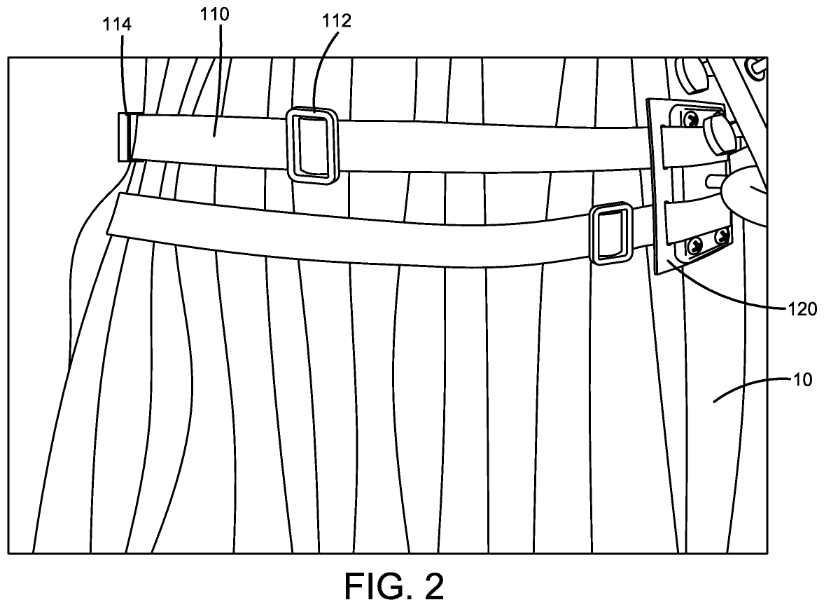

As seen in FIG. 2, the length of the strap 110 may be adjusted with at least one adjustment fastener 112 to fit securely around an object of any size. The adjustment fastener 112 may include, but is not limited to, a buckle, a sliding fastener, etc. The securing fastener 114 is preferably (but not limited to) a clip or buckle which allows the strap 110 to be secured around an object 10, surface, etc.

The mounting plate 120 of the device 100 is preferably made from a metal or plastic material. The mounting plate 120 may be comprised of at least one opening 122 through which the strap 110 of the device can be passed through to secure the mounting plate 120 to the object 10. The mounting plate 120 may be of any size or shape but is preferably a rectangular shape. The shape of the mounting plate 120 is ideally a similar shape to the base 132 of the device 100, such that the holding assembly 130 can be attached (fixedly or removably) to the mounting plate 120 via the base 132.

At least one, but preferably two, receiving arms 134 of the device 100 are attached to the base 132 and extend outwardly. The arms 134 can hold the neck of an instrument such as, but not limited to, a guitar, ukulele, violin, or any other such musical instrument. The receiving arms 134 may be covered in padding 136 in one embodiment to prevent damage to the exterior of the instrument within the arms 134. The padding 136 may be comprised of any padded material. In one embodiment, the arms 134 are bendable/repositionable to accommodate any size, shape, and type of instrument.

In differing embodiments, the receiving arms 134 of the device 100 may also be exchanged for an alternative shape through the undoing of the holding assembly 130 and the new attachment of a different form of receiving arms 134 that sized and configured to hold different instrument types.

The present invention is also comprised of a method of using 200 the device 100. First, a device 100 is provided comprised of at least one strap 110, at least one mounting plate 120, and at least one receiving arm 134 [Step 202]. Then, the strap 110 can be placed through at least one opening 122 of the mounting plate 120 [Step 204]. Then, the strap 110 is placed around an object 10, surface, etc., and secured around the object via the securing fastener 114 [Step 206]. Next, a portion (i.e., a neck) of at least one instrument can be placed within the receiving arms 134 such that the instrument is suspended from the arms 134 above a ground surface [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “outdoor instrument-holding device” and “device” are interchangeable and refer to the outdoor instrument-holding device 100 of the present invention.

Notwithstanding the foregoing, the outdoor instrument-holding device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the outdoor instrument-holding device 100 as shown in the FIGS. are for illustrative purposes only, and that many other sizes and shapes of the outdoor instrument-holding device 100 are well within the scope of the present disclosure. Although the dimensions of the outdoor instrument-holding device 100 are important design parameters for user convenience, the outdoor instrument-holding device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An outdoor instrument-holding device comprising:
a strap;
a mounting plate comprised of an opening; and
a base attached to the mounting plate, the base comprised of a receiving arm.

2. The outdoor instrument-holding device of claim 1, wherein the receiving arm is comprised of a padding.

3. The outdoor instrument-holding device of claim 1, wherein the strap is comprised of an adjustment fastener.

4. The outdoor instrument-holding device of claim 3, wherein the adjustment fastener is comprised of a buckle or a sliding fastener.

5. The outdoor instrument-holding device of claim 1, wherein the strap is comprised of a securing fastener.

6. The outdoor instrument-holding device of claim 5, wherein the securing fastener is comprised of a clip or a buckle.

7. The outdoor instrument-holding device of claim 1, wherein the receiving arm is comprised of a flexible arm.

8. An outdoor instrument-holding device comprising:
a strap comprised of an adjustment fastener and a securing fastener;
a mounting plate comprised of an opening; and
a base attached to the mounting plate, the base comprised of a first receiving arm and a second receiving arm.

9. The outdoor instrument-holding device of claim 8, wherein the first receiving arm and the second receiving arm are comprised of a padding.

10. The outdoor instrument-holding device of claim 8, wherein the adjustment fastener is comprised of a buckle or a sliding fastener.

11. The outdoor instrument-holding device of claim 8, wherein the securing fastener is comprised of a clip or a buckle.

12. The outdoor instrument-holding device of claim 8, wherein the first receiving arm is comprised of a flexible arm.

13. The outdoor instrument-holding device of claim 8, wherein the second receiving arm is comprised of a flexible arm.

14. A method of using an outdoor instrument-holding device, the method comprising the following steps:
providing an outdoor instrument-holding device comprised of a strap, a mounting plate, and a receiving arm;
placing the strap through an opening of the mounting plate;
placing the strap around an object and securing the strap around the object via a securing fastener; and
placing an instrument in the receiving arm such that the instrument is suspended above a ground surface.

15. The method of using an outdoor instrument-holding device of claim 14, wherein the strap is comprised of an adjustment fastener.

16. The method of using an outdoor instrument-holding device of claim 15, wherein the adjustment fastener is comprised of a buckle or a sliding fastener.

17. The method of using an outdoor instrument-holding device of claim 14, wherein the strap is comprised of a securing fastener.

18. The method of using an outdoor instrument-holding device of claim 17, wherein the securing fastener is comprised of a clip or a buckle.

19. The method of using an outdoor instrument-holding device of claim 14, wherein the receiving arm is comprised of a padding.

20. The method of using an outdoor instrument-holding device of claim 14, wherein the receiving arm is comprised of a flexible arm.
